(19) United States
(12) Patent Application Publication
(10) Pub. No.: US 2009/0151924 A1
(43) Pub. Date: Jun. 18, 2009

(54) DOWNHOLE TOOL WITH SHAPE MEMORY ALLOY ACTUATOR

(75) Inventor: Gary B. Lake, Broken Arrow, OK (US)

Correspondence Address: CANTOR COLBURN, LLP, 20 Church Street, 22nd Floor, Hartford, CT, 06103, US

(73) Assignee: BAKER HUGHES INCORPORATED, HOUSTON, TX (US)

(21) Appl. No.: 11/954,407

(22) Filed: Dec. 12, 2007

(51) Int. Cl. E21B 34/06; F16K 31/64

(52) U.S. Cl. 166/53; 166/332.8; 251/11

(57) ABSTRACT

A downhole tool actuator includes a shape memory material; a pulley system engaged with the shape memory material and fixed in position; and a downhole tool component operatively connected to the shape memory material and moveable in response to a phase change of the shape memory material from a martensitic phase to an austenitic phase and method.

### BACKGROUND

Hydrocarbon recovery depends upon actuation of many different types of downhole tools. This can be by hydraulic fluid actuation, electrical actuation, mechanical actuation, and optic actuation. Depending upon the type of actuation or tool to be actuated, or specific properties of the formation where actuation is to take place, different types of actuation are selected as the most fitting for the purpose. In view of the ever-expanding repertoire of tools for the downhole environment, new types of actuation are always well received by the art.

### SUMMARY

A downhole tool actuator includes a shape memory material; a pulley system engaged with the shape memory material and fixed in position; and a downhole tool component operatively connected to the shape memory material and moveable in response to a phase change of the shape memory material from a martensitic phase to an austenitic phase.

A subsurface safety valve includes a housing; a flapper pivotally mounted at the housing; and a shape memory material wire fixedly attached to the flapper and fixedly attached to the housing, the wire having a first length allowing the flapper to be in a closed position and a second length causing the flapper to open.

A safety valve includes a housing; a flow tube disposed at the housing; and a shape memory material actuator fixed to the housing at one end thereof and to the flow tube at the other end thereof, the actuator urging the flow tube into a position associated with a valve open condition when the actuator is transitioned to an austenitic phase.

A method for actuating a safety valve includes affixing one end of a shape memory material in a martensitic phase to a housing of the valve; affixing the other end of the material to a movable valve component; and heating the material to a temperature associated with phase transition to an austenitic phase.

### BRIEF DESCRIPTION OF THE DRAWINGS

Referring now to the drawings wherein like elements are numbered alike in the several Figures:

FIG. 1 is a perspective view of a flapper of a safety valve actuated by a shape memory alloy actuator;

FIG. 2 is the same device as that depicted in FIG. 1 but in an open rather than a closed position;

FIG. 3 is a schematic view of a safety valve actuable by a shape memory alloy wire through the flow tube;

FIG. 4 is the device of FIG. 3 in an open rather than a closed position;

FIG. 5 is a cross-sectional view of a portion of another embodiment of a safety valve actuable with a shape memory alloy actuator;

FIG. 6 is the device illustrated in FIG. 5 but in the open rather than the closed position;

FIG. 7 is another embodiment of a safety valve actuated by a shape memory alloy in the closed position;

FIG. 8 is the device of FIG. 7 illustrated in the open rather than the closed position; and

FIG. 9 is yet another embodiment of a safety valve actuable by a shape memory alloy similar to that of FIGS. 7 and 8 but further employing a traditional torsion spring for alternate failsafe operation.

### DETAILED DESCRIPTION

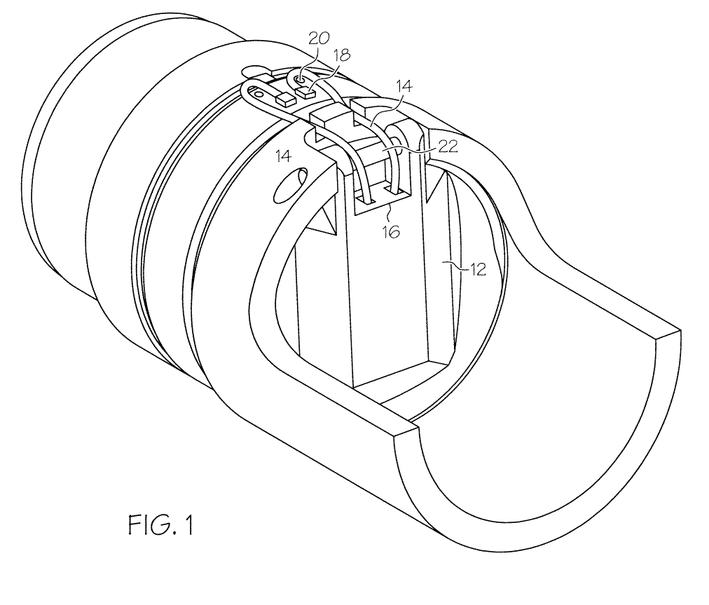

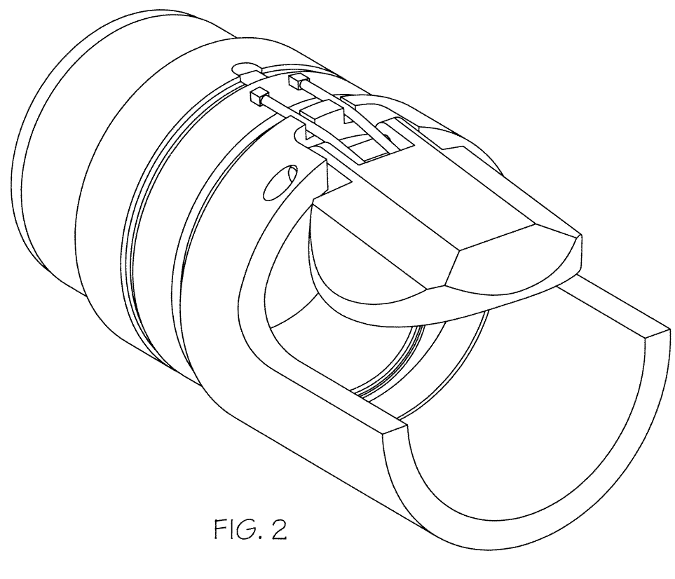

Referring to FIGS. 1 and 2, a first embodiment of a downhole tool actuable with a configuration of shape memory alloy as an actuator is illustrated. In these figures, a small portion of an overall safety valve 10 is illustrated in perspective view focusing upon a flapper 12. It will be noted that the configuration of this device differs from the prior art not only in the actuation via shape memory alloy but in the fact that the flapper 12 will not be opened through the urging of a flow tube (not shown) but rather is directly opened by the shape memory alloy as illustrated. More specifically, one or more shape memory alloy wires 14 are illustrated anchored at flapper anchor point 16. The wire(s) 14 are further anchored at anchor point 18. It is to be appreciated that while both of the wires 14 illustrated in FIG. 1 are shown rounding pulley(s) 20, depending upon the actuation length required pulley(s) 20 may or may not be necessary. Reference to FIG. 2 will make more clear the distinction just noted as the anchors 18 are not disposed on the other side of pulley(s) 20 from wire(s) 14, i.e. the wires are simply terminated without rounding pulleys first. The significance of pulleys will be described later herein.

Ignoring for the moment the pulley configuration and relying for discussion purposes on the arrangement of FIG. 2, it should be apparent that the length of wires 14 is longer when the flapper 12 is closed than it is when the flapper 12 is open. This inherent property borne of the location and path of the wires 14 is utilized to enable actuation of the flapper 12. A shape memory alloy wire having, in a martensitic phase, a first length, and in an austenitic phase, a shorter length allows simple heating of the wire to cause the shortening thereof. Moreover, since the austenitic phase of the shape memory alloy is stronger, there is sufficient strength in the arrangement to move another component of a tool along with the shape memory alloy. When connected as shown to a flapper, for example, the shape memory alloy acts as the actuator for the flapper 12 of the safety valve. More specifically, each wire 14 is trained to have a shorter length in the austenitic phase, roughly equivalent to the length illustrated in FIG. 2, when heated sufficiently to change the material of wire 14 from its martensitic phase to its austenitic phase. Without heating, the wire 14 stays in its martensitic phase, which is as noted, longer such that the flapper 12 is not urged to an open position.

Because it is required for the flapper to close automatically in the event of loss of the impetus from the surface to stay open, in this case, energy or a signal to produce energy (electrical or chemical) used to heat wire 14, a flapper pin 22 in this embodiment is a torsion pin (it is to be appreciated that a traditional non-SMA torsion spring can be used to return the flapper to the closed position as is current standard practice) that is torsionally loaded upon opening of the flapper 12 thereby causing a reactive closing force on the flapper 12 that is operative if the opening impetus from surface is lost. It will also be appreciated that due to the reactive force of torsion pin 22, the shape memory alloy wires 14 must have sufficient strength, when moving to their shorter length, to overcome the bias of the torsions pin 22.

Addressing now the fixed pulley(s) 20 illustrated in FIG. 1, the purpose thereof is to extend the overall length of wire(s) 14. This may in some embodiments be desirable or necessary due to the overall change in length that is required of the shape memory alloy in order to achieve actuation of the tool. Percentage changes on shape memory alloy wires may be up to 12%, however, they are unstable at 12% and therefore in order to ensure a long working life, percentage change in training is better limited to a smaller percentage. In one embodiment, shape memory alloys utilized for actuation of downhole tools is set at about 5%. Clearly, it is easy for one of ordinary skill in the art to determine what length change is necessary to rotate the flapper 12, for example, from the closed position to its open position. This can be as simple as measuring the anchor points on the flapper to the anchor points on the body in the two positions of the flapper. Then it is relatively easy mathematics to determine the total length of shape memory alloy wire necessary to produce, at about 5% change in total length, the desired change necessary to operate the flapper 12. The greater the length of the wire 14 necessary the more likely a pulley 20 would be helpful in creating the actuator. This is because utilizing a fixed pulley allows the shape memory alloy to be maintained in a relatively small local area as opposed to being extended for a relatively long distance from its actual operable component. It will, of course, be appreciated that it is possible to simply extend the wires further up the tool body but this may be undesirable in that the chances of the wire being damaged are greater with exposed length.

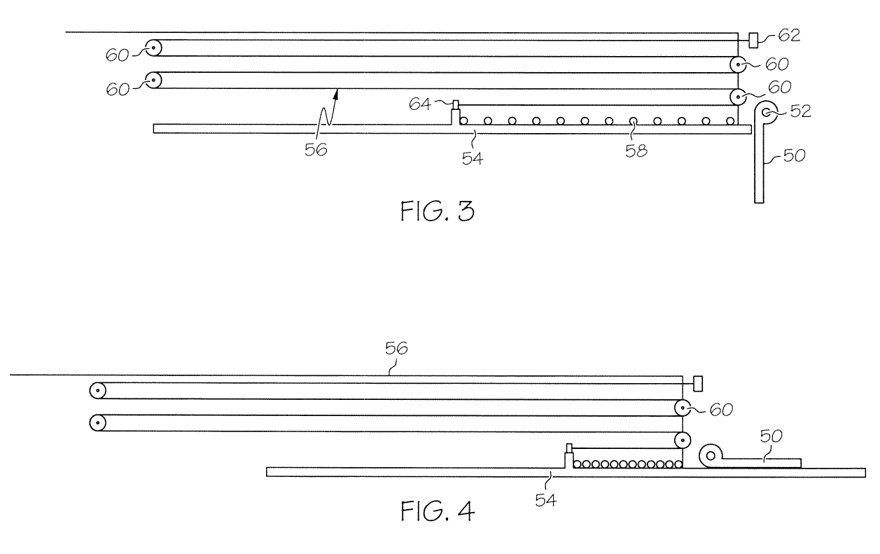

Moving on to FIGS. 3 and 4, another embodiment of the shape memory actuated safety valve is schematically illustrated. In this embodiment, flapper 50 is pivotally mounted at pin 52 and is forcible into an open condition by movement of a flow tube through the position occupied by the flapper 50 in its closed position. Rather than actuating the flow tube 54 by a hydraulic fluid source, as is commonly the case, the present embodiment actuates the flow tube through the use of a shape memory alloy wire 56. This wire is similar to the wire of the previous embodiment in that its' utility is in its' two axial lengths. When the wire in its martensitic phase it is longer; when the wire is heated past a temperature threshold at which the wire enters its austenitic phase it becomes shorter. The wire itself is configured to have sufficient lengthwise change and force to compress a power spring 58 thereby moving the flow tube 54 downhole and through the flapper 50 rotating the same on its pivot pin 52. In order to maintain the shape memory alloy wire in a relatively small area of the downhole tool while endowing it with sufficient length to accomplish its assigned task, it is desirable to supply a number of fixed pulleys 60. These allow one to take advantage of the excess length of shape memory alloy wire in order to gain advantage of the needed total movement required for the flow tube to stroke fully while avoiding having an unwieldy tool due to the length of the shape memory alloy wire. It is important to note that the pulleys must be fixed since if they are not fixed, the length change in the wire will not be realized but rather only torque will be multiplied. With fixed pulleys, however, all of the shortening of the wire will be transmitted to the end component being moved. In the illustration, four pulleys are shown, however, it is noted that more or fewer will be effective depending upon the total length of actuation of the downhole tool being operated. The shape memory alloy wire 56 will, of course, be anchored in anchor spot 62 and in an appropriate position 64 on the flow tube 54 (or other moving component of a tool to be actuated). The position of the relative components of FIG. 3 after actuation are shown in FIG. 4.

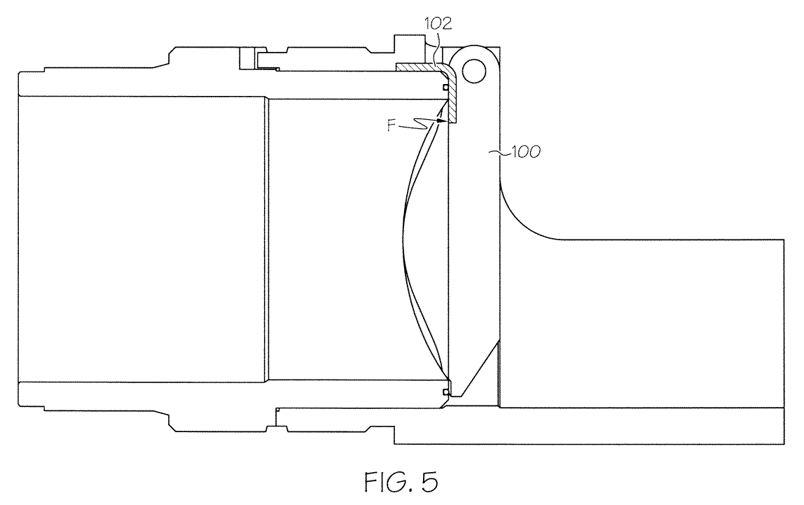

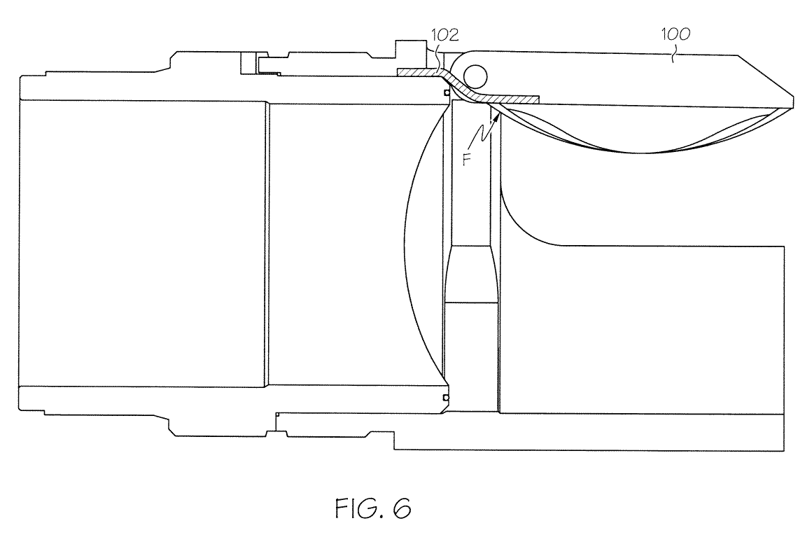

Referring to FIGS. 5 and 6, another embodiment is illustrated wherein a safety valve flapper is actuated using a shape memory alloy actuator but in this instance, utilizing the shape memory alloy in its shape change capacity rather than in its length change capacity. In FIG. 5, flapper 100 is illustrated in its closed position with a shape memory alloy actuator 102 illustrated in a roughly 90° bent position. This will be the martensitic phase of the shape memory alloy. Upon heating the shape memory alloy 102 beyond the threshold temperature required to change the shape memory alloy into its austenitic phase, it will begin to reshape itself into the shape illustrated in FIG. 6. In such a position, the flapper 100 is open. Since, as noted above, the austenitic phase of shape memory alloy is the stronger of the phases, there is no difficulty of the shape memory alloy generating sufficient force to open flapper 100.

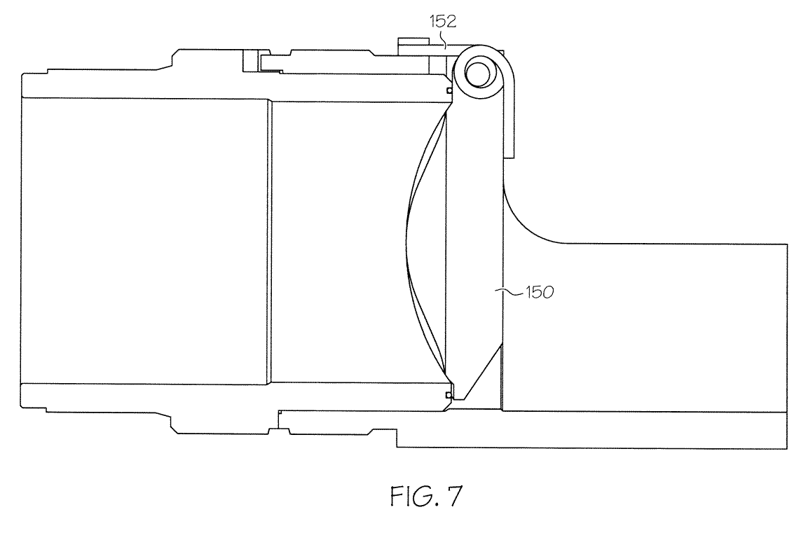

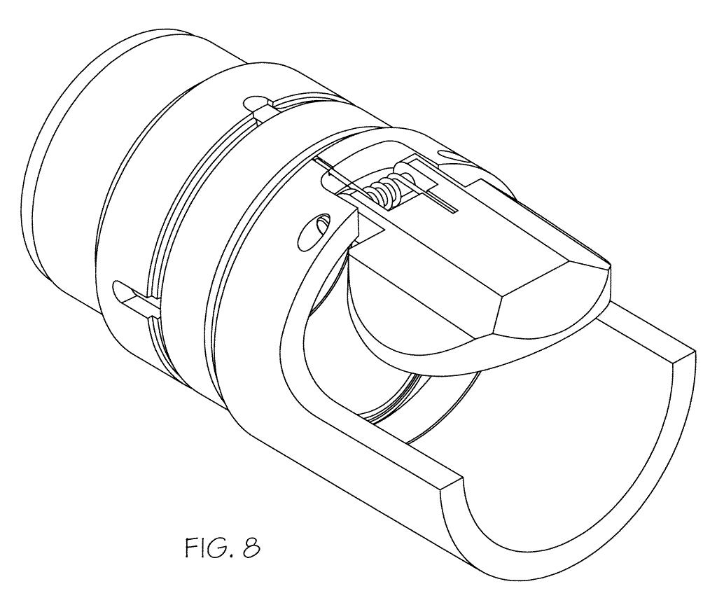

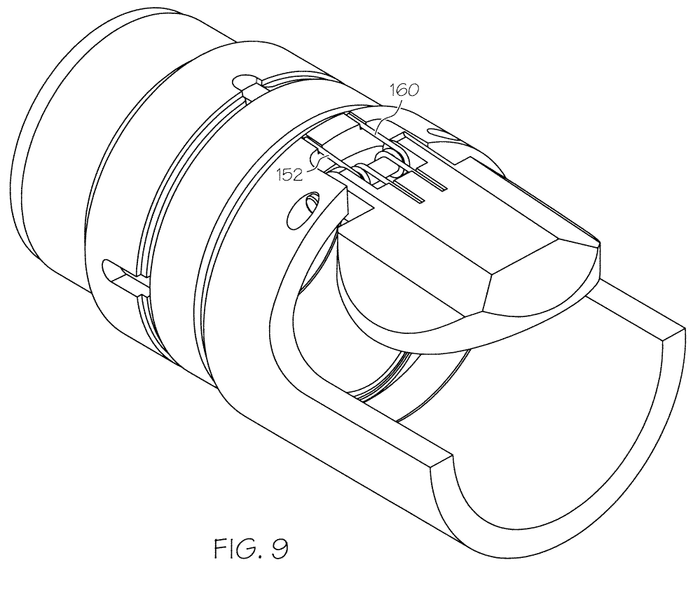

Referring now to FIGS. 7 and 8, the concept of FIGS. 5 and 6 is again repeated in that the shape memory alloy is utilized in its shape change capacity to open flapper 150. It will be appreciated that the shape change material 152 is now illustrated in a coiled configuration similar to that of a common coiled torsion spring. Again the FIG. 7 illustration is in the martensitic phase while the FIG. 8 illustration is in the austenitic phase. Having been exposed to the foregoing, one of ordinary skill in the art will clearly understand that which is disclosed in FIGS. 7 and 8.

Finally, in order to comply with certain regulatory prescriptions in some regions, the concept illustrated in FIGS. 7 and 8 is modified slightly to enhance failsafe operation of the flapper. This is done by adding a traditional torsion spring 160 somewhere adjacent the shape memory alloy torsion spring 152. For the sake of brevity, Applicant has illustrated the device in FIG. 9 only in the open position since it would appear substantially similar to that of FIG. 7 in the closed position. It will be appreciated following the foregoing disclosure that the embodiment of FIG. 9 will require total overall force generated by the shape memory alloy since in this embodiment it is necessary that it overcome the force of torsion spring 160 to open the flapper.

While preferred embodiments have been shown and described, modifications and substitutions may be made thereto without departing from the spirit and scope of the invention. Accordingly, it is to be understood that the present invention has been described by way of illustrations and not limitation.

1. A downhole tool actuator comprising:
a shape memory material;
a pulley system engaged with the shape memory material and fixed in position; and
a downhole tool component operatively connected to the shape memory material and moveable in response to a phase change of the shape memory material from a martensitic phase to an austenitic phase.

2. A subsurface safety valve comprising:
a housing;
a flapper pivotally mounted at the housing; and
a shape memory material wire fixedly attached to the flapper and fixedly attached to the housing, the wire having a first length allowing the flapper to be in a closed position and a second length causing the flapper to open.

3. The valve as claimed in claim 2 further comprising a pivot pin about which the flapper pivots and over which the shape memory material wire is disposed to impart angular momentum to the flapper when the wire is transformed to its second length.

4. The valve as claimed in claim 2 further comprising at least one pulley fixedly located at the valve.

5. The valve as claimed in claim 4 wherein the pulley is rotationally freely engaged with the wire.

6. The valve as claimed in claim 2 wherein the wire is a coiled torsion spring.

7. The valve as claimed in claim 6 wherein the valve further comprises a non-shape memory material torsion spring.

8. A safety valve comprising:
a housing;
a flow tube disposed at the housing; and
a shape memory material actuator fixed to the housing at one end thereof and to the flow tube at the other end thereof, the actuator urging the flow tube into a position associated with a valve open condition when the actuator is transitioned to an austenitic phase.

9. The valve as claimed in claim 8 wherein the actuator is positioned in a tortuous path between the one end and the other end thereof.

10. The valve as claimed in claim 9 wherein the tortuous path is at least one pulley fixedly positioned.

11. The valve as claimed in claim 9 wherein the at least one pulley is rotationally free.

12. The valve as claimed in claim 10 wherein the at least one pulley is a set of pulleys operating in concert to extend a length of the actuator between the housing fixation and the flow tube fixation.

13. A method for actuating a safety valve comprising:
affixing one end of a shape memory material in a martensitic phase to a housing of the valve;
affixing the other end of the material to a movable valve component; and
heating the material to a temperature associated with phase transition to an austenitic phase.

14. The method as claimed in claim 13 further comprising causing the material to follow a tortous path between the housing and the movable component.

15. The method as claimed in claim 13 wherein the heating causes reduction in length of the material.
